(19) United States
(12) Patent Application Publication
(10) Pub. No.: US 2018/0199178 A1
(43) Pub. Date: Jul. 12, 2018

(54) CONCEPT FOR REACTING EFFICIENTLY TO AN EMERGENCY CALL

(71) Applicant: Robert Bosch GmbH, Stuttgart (DE)

(72) Inventor: Stefan Nordbruch, Kornwestheim (DE)

(21) Appl. No.: 15/860,402

(22) Filed: Jan. 2, 2018

(30) Foreign Application Priority Data
Jan. 9, 2017 (DE) 102017200157.7

(51) Int. Cl. H04W 4/90; H04W 4/029; H04M 1/725

(52) U.S. Cl. CPC H04W 4/90; H04M 1/72536; H04W 4/029

(57) ABSTRACT

A method for operating a mobile terminal having a terminal identifier, whereby in reaction to an emergency call sent out by the mobile terminal via a communication network to a subscriber of the communication network, an instantaneous position of the mobile terminal and/or a personal identification assigned to the terminal identifier is/are transmitted automatically to the subscriber via the communication network. A corresponding mobile terminal, a method for operating an emergency call system, an emergency call system, as well as a computer program, are also described.

### CROSS REFERENCE

The present application claims the benefit under 35 U.S.C. § 119 of German Patent Application No. DE 102017200157.7, filed on Jan. 9, 2017, which is expressly incorporated herein by reference in its entirety.

### BACKGROUND INFORMATION

German Patent Application No. DE 10 2013 225 325 A1 describes a method for operating an emergency call system.

### SUMMARY

An object of the present invention is to react efficiently to an emergency call sent out by a mobile terminal via a communication network.

This objective may be achieved in accordance with the present invention. Advantageous developments of the present invention are described herein.

According to one aspect of the present invention, a method is provided for operating a mobile terminal having a terminal identifier, whereby in reaction to an emergency call sent out by the mobile terminal via a communication network to a subscriber of the communication network, an instantaneous position of the mobile terminal and/or a personal identification assigned to the terminal identifier is/are transmitted automatically to the subscriber via the communication network.

According to another aspect, a mobile terminal is provided which is designed to carry out the method for operating a mobile terminal having a terminal identifier.

According to another aspect, a method is provided for operating an emergency call system having a subscriber reachable via a communication network, whereby after the subscriber has received an emergency call sent out to the subscriber via the communication network by a mobile terminal having a terminal identifier, an instantaneous position of the mobile terminal and/or a personal identification assigned to the terminal identifier is/are received by the subscriber from the mobile terminal.

According to a further aspect, an emergency call system is provided which is designed to carry out the method for operating an emergency call system having a subscriber reachable via a communication network.

According to another aspect, a computer program is provided which includes program code for carrying out the method for operating a mobile terminal having a terminal identifier and/or for operating an emergency call system having subscribers reachable via a communication network, when the computer program is executed on a computer, e.g., on a mobile terminal and/or on a subscriber of the communication network.

In accordance with the present invention, after the emergency call has been sent, the mobile terminal automatically transmits an instantaneous position of the mobile terminal and/or a personal identification assigned to the terminal identifier, to that subscriber of the communication network to which the emergency call was previously sent. The subscriber thereby receives relevant information via the communication network, enabling the subscriber or an operator of the subscriber or the user of the subscriber to react efficiently to the emergency call.

Thus, this yields the technical advantage that an efficient concept is provided for reacting efficiently to an emergency call sent out by a mobile terminal via a communication network.

In particular, a subscriber of the communication network within the meaning of the specification denotes a terminal, e.g., a further mobile terminal, or denotes a network server, for example.

The subscriber of the communication network is operated by a regulatory authority, for instance. A regulatory authority within the meaning of the specification is, e.g., a police department, a fire department or an ambulance service, for example.

A personal identification for the purpose of the specification includes, e.g., caller data. For instance, caller data includes a name of the person to whom the mobile terminal is registered, a name of a contact person from an electronic address book of the person to whom the mobile terminal is registered, and/or medical data of the person to whom the mobile terminal is registered.

A terminal identifier is, e.g., an IMSI (International Mobile Subscriber Identity).

The fact that after the emergency call has been sent out, the instantaneous position and the personal identification, respectively, are sent automatically to the subscriber means especially that no manual input or confirmation by a person is necessary for that purpose.

According to one specific embodiment, the communication network includes a wireless and/or wire-bound communication network.

For example, a wireless communication network includes a cellular communication network and/or a WLAN communication network.

According to one specific embodiment, after the emergency call has been sent, a communication link is maintained between the terminal and the subscriber via the communication network.

This yields the technical advantage, for example, that the subscriber is able to efficiently receive further information from the terminal via the communication link without a suitable connection having to be set up again beforehand, which as a rule, takes time.

According to one specific embodiment, the maintenance of the communication link is initiated by the terminal.

According to another specific embodiment, the maintenance of the communication link is initiated by the subscriber.

According to a further specific embodiment, the mobile terminal includes a camera, e.g., a video camera, which after the emergency call has been sent, records images, e.g., video images.

For example, this provides the technical advantage that visual information from the area surrounding the terminal is provided efficiently to the subscriber.

For example, a mobile terminal in terms of the specification is a cellular phone.

A mobile terminal in terms of the specification is a Smartwatch, for instance.

According to one specific embodiment, the images are transmitted by the mobile terminal to the subscriber via the communication network automatically or only after a manual authorization.

For example, this results in the technical advantage that, with the provision of a preceding manual authorization, the user of the mobile terminal retains control over what happens with the recorded images.

With the provision of an automatic transmission of the images, for example, the technical advantage results that the corresponding visual information is made available to the subscriber even if a user of the mobile terminal is no longer able to operate the mobile terminal. Such a situation may occur, for example, if the user of the mobile terminal has become unconscious.

According to one specific embodiment, after the transmission of the emergency call, a broadcast emergency call is sent by the mobile terminal via the communication network and/or via a further communication network, the broadcast emergency call including the instantaneous position and/or the terminal identifier and/or the personal identification.

A broadcast emergency call within the meaning of the specification denotes, in particular, a broadcast emergency call.

For example, this yields the technical advantage that people who receive the broadcast emergency call via their respective further mobile terminals are able to go to the aid of the person having the mobile terminal.

According to one specific embodiment, the mobile terminal determines its instantaneous position using a position sensor, e.g., a GPS sensor.

According to one specific embodiment, the mobile terminal determines its instantaneous position on the basis of a WLAN position finding and/or on the basis of a cellular position finding.

The instantaneous position of the mobile terminal has thus been determined by it, i.e., by itself.

According to one specific embodiment, the mobile terminal includes a position sensor, e.g., a GPS sensor.

According to one specific embodiment, the communication network includes a public communication network and/or a private communication network.

In particular, a private communication network denotes a communication network which is operated by a private person or by a private firm.

A public communication network denotes especially a communication network which is operated by the public sector or by the state.

In the private communication network, for example, private IP addresses are assigned to the individual subscribers of the private communication network.

In one specific embodiment, the communication network is a private communication network.

According to one specific embodiment, the mobile terminal includes a communication interface which is designed to send out an emergency call via a communication network to a subscriber of the communication network.

According to one specific embodiment, the communication interface of the mobile terminal is designed to send an instantaneous position of the mobile terminal and the personal identification, respectively, via the communication network to the subscriber.

According to one specific embodiment, upon reception of the instantaneous position of the mobile terminal, an area surrounding the mobile terminal is monitored by a monitoring device which is different from the mobile terminal.

For example, this provides the technical advantage that further information about the area surrounding the mobile terminal and thus about the user who has sent out the emergency call may be acquired in efficient manner.

According to one specific embodiment, the subscriber of the communication network to which the emergency call was sent operates the monitoring device by remote control.

For example, according to one specific embodiment, remote-control commands for the remote control are transmitted to the monitoring device via the communication network.

According to one specific embodiment, the monitoring device includes one or more of the following monitoring elements: sensor, e.g., video sensor, satellite.

For example, this yields the technical advantage that the surroundings may be monitored efficiently.

Thus, for instance, satellite-supported monitoring of the surroundings is made possible. In particular, sensor-supported monitoring of the surroundings is permitted. Notably, video surveillance of the surroundings is enabled.

For example, the sensor is mounted on an infrastructure element in the area surrounding the mobile terminal which sent out the emergency call. Illustratively, an infrastructure element is a building, a lamp post, a traffic light or a traffic sign.

For instance, a plurality of sensors are provided which, e.g., are identical or, e.g., are constructed differently.

For example, a sensor for the purpose of the specification is one of the following sensors: radar sensor, ultrasonic sensor, lidar sensor, laser sensor, video sensor, especially video sensor of a video camera, magnetic sensor, infrared sensor.

Because the subscriber knows the instantaneous position of the mobile terminal, it thus knows whether within the surroundings of the mobile terminal, there is a sensor which additionally is able to monitor the surroundings of the mobile terminal and to send surroundings data corresponding to the monitoring to the subscriber via the communication network.

Therefore, according to one specific embodiment, a sensor in the area surrounding the instantaneous position of the mobile terminal monitors the position of the mobile terminal and transmits monitoring data corresponding to the monitoring to the subscriber via the communication network.

According to one specific embodiment, upon reception of the instantaneous position of the mobile terminal, an area surrounding the mobile terminal is illuminated by a lighting device that is different from the mobile terminal and that includes a streetlight, for example.

For instance, this provides the technical advantage that, e.g., monitoring is improved because of the better lighting. This especially yields the technical advantage that rescue personnel, when they arrive at the current position of the mobile terminal, are then able to efficiently take in visually the situation that actually exists and what aid measures are necessary.

For example, the lighting device is activated. For instance, the streetlight is thus switched on.

According to one specific embodiment, if, after sending the emergency call, the mobile terminal has transmitted a broadcast emergency call via the communication network and/or via a further communication network, the broadcast emergency call including the instantaneous position and/or the terminal identifier and/or the personal identification, the subscriber then receives information pertaining to the emergency call and sent via the communication network to the subscriber of the communication network by one or more receivers of the broadcast emergency call.

For example, this provides the technical advantage that further information pertaining to the emergency call is made available to the subscriber of the communication network.

For instance, this information includes sensor data, particularly image data, especially video data, from the receivers of the broadcast emergency call.

A receiver of the broadcast emergency call is a further mobile terminal, for example. For instance, the further mobile terminal is a cell phone.

In other words, according to one specific embodiment, it is thus provided that a receiver of the broadcast emergency call automatically records video images with the aid of its video camera, and these video images are transmitted automatically to the subscriber of the communication network to which the original emergency call was sent.

According to one specific embodiment, the emergency call system includes the subscriber.

According to one specific embodiment, the subscriber includes a communication interface which is designed to receive an emergency call sent out by a mobile terminal.

According to one specific embodiment, the communication interface of the subscriber is designed to receive an instantaneous position of the mobile terminal and a personal identification assigned to the terminal identifier, respectively, from the mobile terminal via the communication network.

According to one specific embodiment, the emergency call system, e.g., the subscriber, includes a control device for controlling the monitoring device and the lighting device, respectively.

According to one specific embodiment, the emergency call system includes the monitoring device and the lighting device, respectively.

According to one specific embodiment, the emergency call system includes the receivers of the broadcast emergency call.

In particular, the formulation “respectively” includes the formulation “and/or.”

Technical functionalities of the mobile terminal are derived analogously from corresponding technical functionalities of the method for operating a mobile terminal having a terminal identifier, and vice versa.

Analogously, technical functionalities of the emergency call system are derived directly from corresponding technical functionalities of the method for operating an emergency call system having a subscriber reachable via a communication network, and vice versa.

According to one specific embodiment, the method for operating a mobile terminal having a terminal identifier is implemented or carried out with the aid of the mobile terminal.

According to one specific embodiment, the method for operating an emergency call system having a subscriber reachable via a communication network is implemented or carried out with the aid of the emergency call system.

According to one specific embodiment, in reaction to the received emergency call, rescue personnel, e.g., police and/or fire department and/or a doctor and/or a paramedic is/are sent to the position of the mobile terminal.

In one specific embodiment, the mobile terminal includes a microphone by which, after the transmission of the emergency call, noise in the area surrounding the mobile terminal is recorded automatically or only after manual authorization, audio data corresponding to the recording being transmitted via the communication network to the subscriber.

For example, this yields the technical advantage that ambient noise may be made available efficiently to the subscriber.

In one specific embodiment, the subscriber stores the data sent by the mobile terminal. For example, this data includes: emergency call, audio data, video data, video images, position, terminal identifier, personal identification.

For example, this provides the technical advantage that this data is also available at a later time and, for instance, may then be analyzed. For example, this may facilitate a presentation of evidence.

The present invention is explained in greater detail below on the basis of preferred exemplary embodiments.

### BRIEF DESCRIPTION OF THE DRAWINGS

FIG. 1 shows a flowchart of a method for operating a mobile terminal having a terminal identifier.

FIG. 2 shows a mobile terminal.

FIG. 3 shows a flowchart of a method for operating an emergency call system having subscribers reachable via a communication network.

FIG. 4 shows an emergency call system.

FIG. 5 shows an exemplary application scenario.

### DETAILED DESCRIPTION OF EXAMPLE EMBODIMENTS

FIG. 1 shows a flowchart of a method for operating a mobile terminal having a terminal identifier.

According to the method, in reaction to an emergency call sent out by the mobile terminal via a communication network to a subscriber of the communication network, in a step 101, an instantaneous position of the mobile terminal and/or a personal identification assigned to the terminal identifier is/are sent automatically via the communication network to the subscriber.

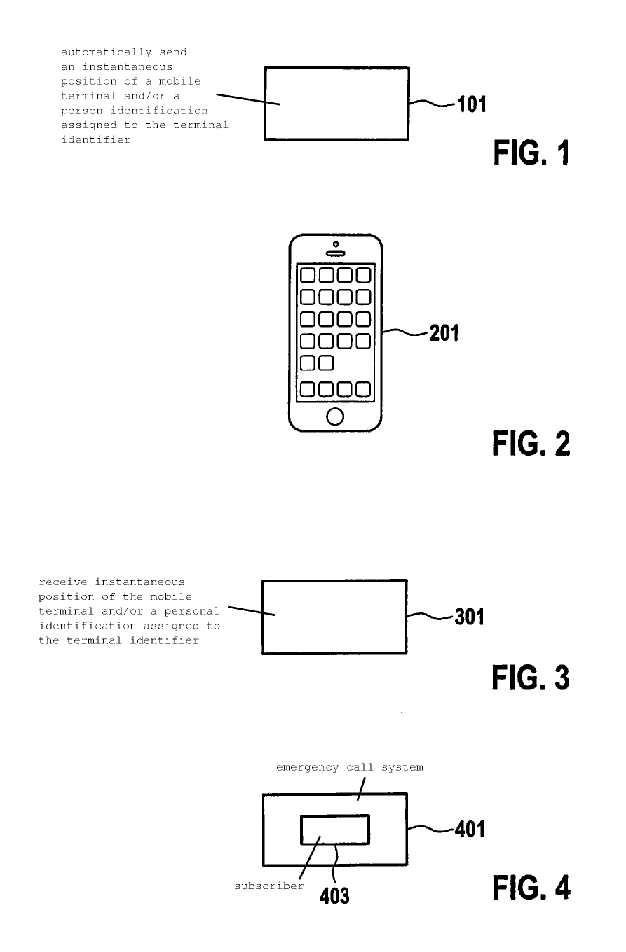

FIG. 2 shows a mobile terminal 201 which is a cell phone, for example.

Mobile terminal 201 is designed to carry out or implement the method for operating a mobile terminal having a terminal identifier.

FIG. 3 shows a flowchart of a method for operating an emergency call system having a subscriber reachable via a communication network.

The method provides that after the subscriber has received an emergency call sent out to the subscriber via the communication network by a mobile terminal having a terminal identifier, according to a step 301, an instantaneous position of the mobile terminal and/or a personal identification assigned to the terminal identifier is/are received by the subscriber from the mobile terminal.

FIG. 4 shows an emergency call system 401 including a subscriber 403 reachable via a communication network.

Emergency call system 401 is designed to implement or carry out the method for operating an emergency call system having a subscriber reachable via a communication network.

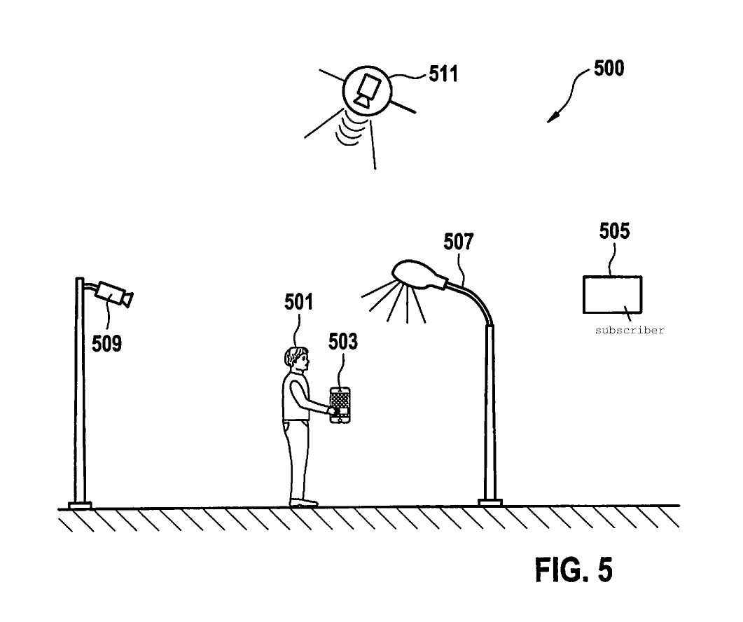

FIG. 5 shows an exemplary application scenario 500 according to the invention.

A person 501 sends an emergency call via a cell phone 503 to a subscriber 505 of a communication network. For instance, subscriber 505 is a network server and is operated, for example, by the police department or the fire department.

After the emergency call has been sent, cell phone 503 automatically transmits an instantaneous position of cell phone 503 via the communication network to subscriber 505.

Subscriber 505 or its operator, thus, e.g., the police department or the fire department, is therefore informed about where person 501 is located. Accordingly, subscriber 505 checks, for example, whether within the area surrounding person 501, there are sensors for monitoring the surroundings of person 501 and/or whether there is a lighting device that is able to illuminate the area surrounding person 501.

In the present application scenario 500, a streetlight 507 is in the area surrounding person 501. Subscriber 505 switches on streetlight 507 using a remote-control command, so that it illuminates the area surrounding person 501 more brightly.

Moreover, in exemplary application scenario 500, a video camera 509 is present in the area surrounding person 501. Subscriber 505 operates video camera 509 by remote control via the communication network in such a way that video camera 509 records video images of the area surrounding person 501, and transmits them to subscriber 505 via the communication network. Thus, for example, the police or the fire department receives visual monitoring data of the area surrounding person 501.

Furthermore, in exemplary application scenario 500, a satellite 511 is able to monitor the surroundings of person 501. Accordingly, subscriber 505 operates satellite 511 by remote control in such a way that satellite 511 monitors the area surrounding person 501 and transmits corresponding monitoring data to subscriber 505. In other words, according to application scenario 500, the area surrounding person 501 is thus monitored by satellite.

In accordance with the present invention, after an emergency call has been sent, a personal identification, e.g., caller data, is also transmitted automatically to that subscriber of the communication network to which the emergency call has also already been sent.

In particular, after the transmission of the emergency call, position data is transmitted automatically to the subscriber of the communication network. Position data corresponds to the instantaneous position of the mobile terminal.

In another specific embodiment, an interconnection of the mobile terminal with the subscriber of the communication network is set up for a remote access to the mobile terminal. Here, for example, after the emergency call has been sent, a communication link is maintained between the terminal and the subscriber via the communication network.

According to one specific embodiment, the subscriber of the communication network accesses the mobile terminal via the communication link in order, for example, to tap and/or to read out sensor data, e.g., video data or video images, and/or taps and/or reads out this sensor data.

According to one specific embodiment, after the emergency call has been sent out, one or more cameras, e.g. video cameras of the mobile terminal are activated, in particular, are activated automatically.

In one specific embodiment, images, especially video images (films) of the area surrounding the mobile terminal are recorded by the one or more cameras.

According to a further specific embodiment, the recorded images and/or video images (films) are sent or transmitted to the subscriber of the communication network. For example, this transmission is carried out either automatically or, e.g., only after an authorization on the part of a user of the mobile terminal.

In this way, information relevant for the emergency case is available quickly and efficiently to the regulatory authority, for instance, or the rescue personnel, e.g., the fire department or police department.

According to one specific embodiment, based on the position of the mobile terminal and/or the personal identification, further information is determined and/or further actions are initiated by the regulatory authority via an infrastructure.

Examples for further information include, e.g., data from surveillance cameras located in the area surrounding the mobile terminal. In other words, the area surrounding the mobile terminal, thus, especially the position of the mobile terminal, is monitored, for example, via public infrastructure sensors, e.g., video cameras and/or satellites.

For example, actions include switching on lights and/or altering lighting conditions in the area surrounding the mobile terminal. For instance, one or more streetlights is/are switched on.

An action includes, for example, that rescue personnel are sent to the current position of the mobile terminal.

In one specific embodiment, in addition to the transmission of the emergency call to the subscriber, a broadcast emergency call is sent via the communication network and/or via a further communication network.

For example, a further communication network is designed analogously to the communication network.

Thus, it is provided, for instance, that the broadcast emergency call is sent via private WLAN communication networks.

This broadcast emergency call may be referred to, e.g., as a local emergency call. For instance, this local emergency call is able to be received by further terminals, e.g., mobile terminals, e.g., cell phones and/or motor vehicles and/or infrastructure terminals which are in the area surrounding the mobile terminal that has sent out the emergency call. Accordingly, for example, the users or operators of these further terminals may then gather further information, e.g., may take video images of the surroundings or of the person having the mobile terminal and/or provide assistance.

According to one specific embodiment, these further terminals receive a sent-along emergency-case ID by which, for example, the regulatory authority is able to access the information which these further terminals ascertain. For example, this emergency-case ID is likewise sent from the mobile terminal to the regulatory authority.

According to one specific embodiment, a user of the mobile terminal is able to set what data is transmitted to the subscriber. In other words, the user may thus decide, for example, whether or not the video camera automatically takes images.

In particular, the present invention may be used within public communication networks and/or private communication networks.

For example, the present invention has the advantage that quick and extensive information about the incident which has triggered the emergency call and about the area surrounding the mobile terminal is made available.

A further advantage according to the invention may be seen especially in the fact that information of the caller is able to be verified using the personal identification and/or the instantaneous position. It is thus possible, for example, to avoid situations where misinformation which, e.g., is input consciously or unconsciously into the mobile terminal, leads to false reactions. For instance, a further advantage may be seen in that negative results may thereby be prevented.

What is claimed is:

1. A method for operating a mobile terminal having a terminal identifier, comprising:
in reaction to an emergency call sent out by the mobile terminal via a communication network to a subscriber of the communication network, transmitting automatically at least one of an instantaneous position of the mobile terminal and a personal identification assigned to the terminal identifier, to the subscriber via the communication network.

2. The method as recited in claim 1, wherein after the emergency call has been sent, a communication link is maintained between the terminal and the subscriber via the communication network.

3. The method as recited in claim 1, wherein the mobile terminal includes a video camera, which, after the emergency call has been sent, records video images.

4. The method as recited in claim 3, wherein the images are transmitted by the mobile terminal to the subscriber via the communication network one of automatically or only after a manual authorization.

5. The method as recited in claim 1, wherein the mobile terminal includes a microphone by which, after the transmission of the emergency call, noise in an area surrounding the mobile terminal is recorded automatically or only after manual authorization, audio data corresponding to the recording being transmitted via the communication network to the subscriber.

6. The method as recited in claim 1, wherein after the transmission of the emergency call, a broadcast emergency call is sent by the mobile terminal via at least one of the communication network and a further communication network, the broadcast emergency call including at least one of the instantaneous position, the terminal identifier, and the personal identification.

7. The method as recited in claim 1, wherein the communication network is a private communication network.

8. A mobile terminal having a terminal identifier, the mobile terminal designed to:
in reaction to an emergency call sent out by the mobile terminal via a communication network to a subscriber of the communication network, transmitting automatically at least one of an instantaneous position of the mobile terminal and a personal identification assigned to the terminal identifier, to the subscriber via the communication network.

9. A method for operating an emergency call system having a subscriber reachable via a communication network, the method comprising:
after the subscriber has received an emergency call sent out to the subscriber via the communication network by a mobile terminal having a terminal identifier, receiving at least one of an instantaneous position of the mobile terminal and a personal identification assigned to the terminal identifier, by the subscriber from the mobile terminal.

10. The method as recited in claim 9, wherein upon reception of the instantaneous position of the mobile terminal, an area surrounding the mobile terminal is monitored by a monitoring device which is different from the mobile terminal.

11. The method as recited in claim 10, wherein the monitoring device includes at least one of the following monitoring elements: a sensor, a video sensor, and a satellite.

12. The method as recited in claim 9, wherein upon reception of the instantaneous position of the mobile terminal, an area surrounding the mobile terminal is illuminated by a lighting device that is different from the mobile terminal and that includes a streetlight.

13. The method as recited in claim 9, wherein if, after sending the emergency call, the mobile terminal has transmitted a broadcast emergency call via at least one of the communication network and a further communication network, the broadcast emergency call including at least one of the instantaneous position, the terminal identifier, and the personal identification, the subscriber then receives information pertaining to the emergency call and sent via the communication network to the subscriber of the communication network by at least one receiver of the broadcast emergency call.

14. The method as recited in claim 9, wherein the subscriber stores data sent by the mobile terminal, the data including at least one of emergency call data, audio data, video data, video images, position, terminal identifier, and personal identification.

15. An emergency call system having a subscriber reachable via a communication network, the emergency call system designed to:
after the subscriber has received an emergency call sent out to the subscriber via the communication network by a mobile terminal having a terminal identifier, receive at least one of an instantaneous position of the mobile terminal and a personal identification assigned to the terminal identifier, by the subscriber from the mobile terminal.

16. A non-transitory computer-readable storage medium on which is stored a computer program including program code for operating a mobile terminal having a terminal identifier, the computer program, when executed by a computer, causing the computer to perform:
in reaction to an emergency call sent out by the mobile terminal via a communication network to a subscriber of the communication network, transmitting automatically at least one of an instantaneous position of the mobile terminal and a personal identification assigned to the terminal identifier, to the subscriber via the communication network.
